(19) United States
(12) Patent Application Publication
(10) Pub. No.: US 2025/0004740 A1
(43) Pub. Date: Jan. 2, 2025

(54) OPTIMIZED MICROSERVICE-BASED ARCHITECTURE FOR A COST BASIS CALCULATION PLATFORM

(71) Applicant: Mark MUELLER-EBERSTEIN, Bellevue, WA (US)

(72) Inventor: Mark MUELLER-EBERSTEIN, Bellevue, WA (US)

(21) Appl. No.: 18/215,705

(22) Filed: Jun. 28, 2023

(51) Int. Cl. G06F 8/65; G06Q 20/38

(52) U.S. Cl. CPC G06F 8/65; G06Q 20/389

(57) ABSTRACT

Information on one or more microservices associated with a data processing platform that provide one or more data processing functionalities are distributed to various entities. Likewise, information on one or more data sources that provide one or more sets of financial data for processing by the data processing platform are distributed to such entities. Candidate code for a new service feature that uses at least one of microservices associated with the data processing platform that processes the financial data may be received from an entity of such entities. The new service feature coded by the candidate code is presented via a corresponding blockchain application to an organization that operates the data processing platform for potential integration into the data processing platform. The new service feature may be deployed as a part of the data processing platform in response to the set of conditions for deployment fulfilled.

### BACKGROUND

Enterprises such as exchange entities may handle a large number of financial transactions daily. As technology advances, cryptocurrency is being used increasingly, on and off the blockchain, as payment for goods and services for both domestic and international transfers, and in a new and evolving suite of protocols known as “Decentralized Finance” (DeFi) as “Non-Fungible Tokens” (NFTs), allowing complex transactions such as borrowing and lending, on-chain exchanges, and synthetic assets. Associated with the increasing use of cryptocurrency is a complicated calculation of tax liabilities and generation of financial reports for subscribers and/or government entities.

Further, the microservices architecture is a software architecture in which a software application is structured as a set of discreet services that perform separate tasks to achieve data processing objectives. The microservices may be loosely coupled and independently deployed or removed as the functionalities of the software application is updated. In some instances, the microservices that make ups the software application may communicate with each other via RESTful application program interfaces (APIs), in which the data exchanged by the microservices are stateless. In other words, each of the microservices does not depend on any previously stored context to process the current data from another microservice.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture that implements a platform for generating financial reports, in accordance with at least one embodiment.

FIG. 2 is a block diagram for receiving and storing an internal representation of external data to a database, in accordance with at least one embodiment.

FIG. 3 is a block diagram for pre-processing transaction data to facilitate a generation of the financial reports, in accordance with at least one embodiment.

FIG. 4 is a block diagram of an example trade action that includes selling and buying of assets, in accordance with at least one embodiment.

FIG. 5 is a block diagram of a financial transaction processing center (FTPC) server that implements the generating of the financial reports, in accordance with at least one embodiment

FIG. 6 is a swimlane diagram illustrating an example cost basis calculation over financial transactions incurred by a subscriber in a tax year, in accordance with at least one embodiment.

FIG. 7 is a flow diagram of an example procedure for generating the financial reports, in accordance with at least one embodiment.

FIG. 8 is a flow diagram of an example procedure for improving a cost basis calculation based on atomic primitive operations, in accordance with at least one embodiment.

FIG. 9 illustrates a microservice-based implementation of the cost basis setting platform that generates financial reports, in accordance with at least one embodiment.

FIG. 10 is a block diagram illustrating the generation of candidate codes to provide new service features for a cost basis setting platform based at least on the microservices of the platform, in accordance with at least one embodiment.

FIG. 11 is a flow diagram of an example process for using a microservice-based architecture of a data processing platform to generate and integrate service features into the platform, in accordance with at least one embodiment.

### DETAILED DESCRIPTION

This disclosure is directed to a platform that utilizes one or more atomic primitive operations to determine content of a financial report. In one embodiment, the platform may generate a financial report such as a profit-and-loss (PnL) report, fees report, a debt report, or a holdings report. In this embodiment, the platform may retrieve from a database corresponding transaction data that includes at least one action involving one or more assets from a blockchain-based financial transaction or off blockchain. The platform may then generate zero, one or more atomic primitive operations for the at least one action and use generated operation(s) to determine the content (e.g., taxable income, fees) of the financial report. In some examples, an action or actions may generate no operations on the asset, such as in the instance of a failed transaction, which may be represented by a transaction object containing an action that does not generate operations. In one instance, the generated one or more atomic primitive operations may be used to improve cost basis calculation for at least one action by comparing results from different cost basis methods (e.g., first-in-first-out (FIFO) cost basis method, last-in-first-out (LIFO) cost basis method). The platform may store the content into the database and/or transmit the content as e.g. a financial report, formatted and unformatted “report data”, including an “Application Programming Interface” API call response to the subscriber or third parties such as a banking institution, tax agency, and the like.

As described herein, the action may include a transitioning of states by the asset in accordance, for example, with a smart contract protocol or workflow. The state may represent an instance while the transitioning of states can represent the atomic primitive operation(s) of the action where the instance can change its state. In one embodiment, the action involving one or more assets may include a trading action such as selling and buying assets, a discarding action such as donating the asset, a minting action such as mining or receiving an asset in an airdrop, a depositing or withdrawing action, a borrowing action, a payback action, an asset transfer-out action, and/or an asset transfer-in action. Here, the action may generate one or more atomic primitive operations, which can be representative of components of the action.

For example, the generated components (or atomic primitive operations) from the action may include a buying of an asset (referred to as a BuyOp), selling of the asset (referred to as SellOp), borrowing of the asset (referred to as BorrowOp), paying back of an account (referred to as PaybackOp), discarding of the asset as if nothing is received (referred to as DiscardOp), adjusting of cost basis (referred to as AdjustOp), earning or losing an amount (positive or negative) of USD (referred to as USDEarnOp, representing a taxable gain (loss)), and/or receiving USD (referred to as USDReceiveOp, representing a non-taxable receipt of USD). Each of these components, or in combination with one or more different components, may be used to generate the content of the financial report. In one embodiment, the platform may perform a pre-processing of the transaction data in multiple passes that can include generation and matching of the atomic primitive operations regardless of type of requested report from the subscriber. In another embodiment, the platform may perform the pre-processing of the transaction data upon detection of a triggering event such as receiving of a new data upload or a subscriber request for a particular report. In some other embodiment, the platform may perform the pre-processing of the transaction data during a preconfigured interval such as every minute, hour, etc.

The platform may include software, hardware, or a combination thereof, to leverage the use of the atomic primitive operations to facilitate the generation of the financial report as described herein. To receive the financial data from the different external sources such as blockchain-based financial transactions (e.g., Ethereum, Bitcoin), centralized and decentralized exchange and entities exported data (e.g., Coinbase, BitGo), or customer-supplied data, the platform may use an open-source system such as an APACHE® KAFKAR to reliably receive and decouple financial or transaction data from the external heterogeneous sources. For example, external data streams from the heterogeneous sources may be pushed into a streaming platform such as the APACHE® KAFKAR, and the external data streams can be decoupled and stored into the database without losing control of continuity of the external data streams in the streaming platform. The decoupled external data streams may be parsed and stored into the database as a non-relational document database that can provide support for JSON-like storage, or similar document-based non-relational management system e.g., MongoDB. Here, the stored transaction data may include a unified internal representation of the parsed financial data from the different external sources or data.

In one embodiment, the platform may associate one or more atomic primitive operations to a particular stored transaction data based upon the metadata, and other details of the parsed transaction data to be stored in the database. For example, a trading action component—BuyOp may be associated by the platform to a particular stored transaction data when corresponding parsed external data (or trading action) shows decrease in a subscriber's dollar account and an increase in number of assets in between states. In another example, a trading action—SellOp may be associated by the platform to another stored transaction data when the corresponding parsed external data (or trading action) includes an increase in the subscriber's dollar account and a decrease in the number of assets during state transition, and so on. In these examples, the trading action may generate the associated atomic primitive operations that can represent financial activity of the subscriber. In another embodiment, the atomic primitive operations need not be initially associated during transaction data loading and the platform may request the trading action to generate the operations based on specified logic. In these embodiments, the stored transaction data may include the ID for the atomic primitive operations, transaction ID, source node ID, destination node ID, and the like.

With the stored transaction data, the platform may generate, for example, a subscriber requested financial report on the subscriber's latest blockchain-based financial transaction(s), such as buying and selling of a particular cryptocurrency (i.e., trading action) over a particular time period. The time period may include a previous hour, day, week, or any other period. In this example, the platform may query and retrieve the stored transaction data that correspond to the financial report to be generated. The retrieved transaction data may include at least one action that involves one or more assets from the blockchain-based transaction.

With the queried transaction data, the platform may then assign a value or price to the queried transaction data and particularly to the one or more assets that are involved in the action. The assigning of value or price may be based upon a price of the asset that participated in the action at the time of the transaction. In one embodiment, the platform may use a consistent and transparent centralized validation table of value to time when pricing or assigning values to the asset based upon the time of the transaction involving the asset. The centralized validation table may store prices of the assets at different time periods, different exchange sources, or a combination thereof, that can be used as a reference for the assigning of values to the asset.

For example, the centralized validation table may include information such as types and sources for the assets, transaction dates, and corresponding prices of the assets at the different transaction dates. Here, the prices of the assets at different transaction date may utilize the United States dollar (USD) as a base currency. In this example, the centralized validation table may provide a uniform price source for the assigning of values to the queried transaction data.

Following the assigning of values to the queried transaction data, the platform may then generate the atomic primitive operations for the one or more actions in the transaction data. In one embodiment, the platform may use the information recorded in the transaction data as well as additional information such as a locational jurisdiction of the subscriber for tax purposes, to generate preconfigured atomic primitive operations that can be representative of financial activities of actions in the queried transaction data. In this embodiment, the preconfigured atomic primitive operations in the database may include the AdjustOp, DiscardOp, and the like.

With the generated atomic primitive operations for the one or more actions in the transaction data, the platform may match the generated atomic primitive operation with another atomic primitive operation. Without limitation, the platform may use a table of preconfigured pairings as a reference for the matching. In some embodiments, the pairings may be created and updated by the platform and/or by the user, and may support machine learning, artificial intelligence, and/or the like enhancements. For example, the generated atomic primitive operations that can be matched with one another can include the pairings between the generated BuyOp and the generated SellOp; BorrowOp and the PaybackOp; BorrowOp and the SellOp; BuyOp and the PaybackOp; BuyOp and the DiscardOp; and the BorrowOp and the DiscardOp. In this example, the platform allows matches only between “producing” operations (BuyOp and BorrowOp) and “consuming” operations (SellOp, PaybackOp and DiscardOp). For example, matching a SellOp with a PaybackOp is disallowed. USD operations such as the USDEarnOp and the USDReceiveOp may not be matched as described herein. Further, the AdjustOp, which is a “meta” operation that acts on the BuyOps and the SellOps to adjust cost basis or proceeds may not be matched with another atomic primitive operation.

For example, the associated atomic primitive operations from the queried transaction data may include a BuyOp on account of buying 10 ETH by the subscriber and a SellOp on account of selling 20 ETH by the subscriber within a particular time period. In this example, and based upon preconfigured pairing-references as enumerated above, the BuyOp may be matched with the SellOp. This pairing, for example, may be implemented to determine an income value between the trading action operation within the particular time period. Here, a particular action may generate the AdjustOp to adjust the cost basis in the BuyOps or the proceeds in the SellOps. The action may link the AdjustOp to this trading action or can leave the trading action unlinked in which case the platform may again attempt to link the AdjustOp to the BuyOps and SellOps at a later stage of a pre-processing pipeline as described herein.

After the matching in the preceding example, the platform may repeat the matching step again using different cost basis methods (e.g. FIFO, LIFO etc.) to optimize or aim to optimize (e.g., within a tolerance), for example, the cost basis calculation for the queried transaction data. By determining and implementing the cost basis method that generates a favorable cost basis, the platform may be able to select the cost basis method to be applied to the determined income value to reduce the subscriber's taxable income.

In one embodiment, the value assignment and generation of the atomic primitive operations may be performed prior to receiving of the subscriber request or interaction with the user. In this embodiment, the platform may send notification alerts to the subscriber or user without initial interaction such as requesting for the financial report. Here, the pre-processing of the transaction data may reduce latency for the platform to show reports which the user may have subscribed to receive.

The techniques in the preceding example may be used to generate financial reports for the subscriber, for example expense report, profit report, fees report, holdings report, debt report, and the like. In order to generate the reports the platform may read and process the generated operations, potentially in the context of the actions that contain them. For example a profit report may subtract the proceeds recorded in SellOps from the basis recorded in BuyOps across all actions, whereas a debt report may query only debt actions to tally BorrowOps against PaybackOps contained in them. for example profit and loss. Without limitation, the platform may perform the pre-processing continuously, within a regular predefined interval (e.g., every hour), or upon a detection of a triggering event such as the receiving of the subscriber request.

In various embodiments, the platform as described herein may be implemented using a microservices architecture. The platform may be operated by various type of organizations to provide financial reports to the users of the platform. For example, the organization may be a centralized business organization, a decentralized autonomous organization (DAO), an “open source” organization, and/or other types of finance-related organizations. The microservice architecture of the platform may enable various interested entities, such as members of the organization, users of the platform, third-party software developers, and/or other parties to propose and develop new service features for the platform using the microservices of the platform. Such new service features may be implemented using scripts, executable applications, and blockchain applications, i.e., smart contracts. For example, scripts may be developed to call microservices of the platform and provide new functionalities that interact with the called microservices and third-party data sources. Likewise, executable applications may be coded to interact with microservices of the platform, execute other functionalities in conjunction with the functionalities provided by the microservices, process data from third-party sources, and/or so forth. Additionally, blockchain applications that are executable in a blockchain execution environment may be used to interact with the microservices of the platform, applications or microservices of other data processing platforms, and/or third-party data sources to integrate the functionalities of the platform with functionalities of other financial service platforms. Thus, the microservice architecture of the platform as described herein may provide the platform with a greater degree of flexibility for future feature deployment, service integration with other financial service platforms, including decentralized finance (DeFi) and centralized finance (CeFi) services, as well as forward compatibility with multiple financial services and applications.

Some implementations and operations described herein may be ascribed to the use of a server; however, alternative implementations may execute certain operations in conjunction with or wholly within a different element or component of the system(s). In particular, in accordance with at least one embodiment, server functionality may be distributed across multiple computing devices, including devices that do not primarily and/or typically act in the role of servers such as network edge devices. Further, some of the techniques described herein may be implemented in a number of contexts, and several example implementations and context are provided with reference to the figures. The term “techniques,” as used herein, may refer to system(s), method(s), computer-readable instruction(s), module(s), algorithms, hardware logic, and/or operation(s) as permitted by the context described above and throughout the document.

### Example Architecture

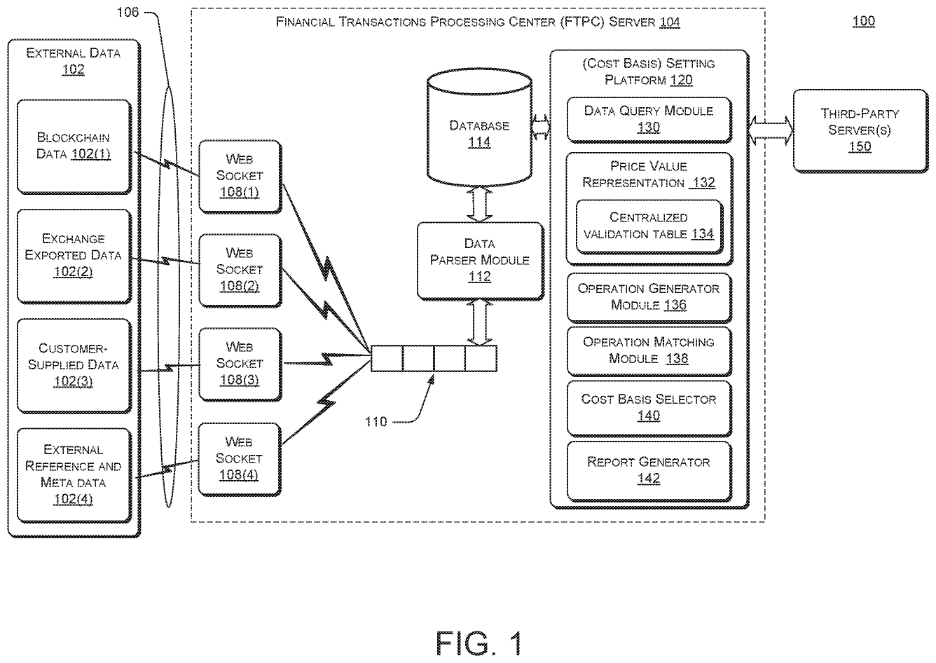

FIG. 1 illustrates a schematic view of an example computing architecture 100 that implements a platform for generating and matching atomic primitive operations to generate one or more financial reports that can be used by a subscriber. For example, the subscriber may subscribe to receive a financial report to establish a favorable cost basis calculation over a particular financial transaction. In accordance with at least one embodiment, external data including blockchain-based financial transactions may be parsed and stored in a non-relational document database that can provide support for JSON-like storage, or a similar document-based non-relational management system. With the stored transaction data, transaction data involving one or more assets from the blockchain-based financial transaction may be queried and retrieved from the non-relational document database. In one embodiment, one or more atomic primitive operations may be generated from the retrieved transaction data. In this embodiment, the generated atomic primitive operations may be matched and processed to generate, for example, the financial report or financial report notification alert to the subscriber. In some embodiments, the financial report notification alert may be based upon a request received from the subscriber or the financial report that the subscriber subscribed to receive. The financial report or financial report notification alert may include a profit and loss report, expense report, profit report, fees report, holdings report, debt report, and the like

As shown, the computing architecture 100 may include external data 102 including, without limitation, blockchain data 102(1), exchange exported data 102(2), customer supplied data 102(3), and external reference and metadata 102(4). The external data 102(1)-102(N) may be connected to a financial transaction processing center (FTPC) server 104 through a network 106. The FTPC server 104 may include, for example, a decentralized and distributed platform for software applications that is immutable and supports consensus and transparency. The FTPC server 104 can also be operated by a third party to provide financial reports to subscribers such as individual taxpayers or other entities.

The FTPC server 104 may implement web sockets 108(1)-108(N), a receiving queue 110, a data parser module 112, database 114, and a (cost basis) setting platform 120 that further includes a data query module 130, a price value representation 132 with a centralized validation table 134, an operation generator module 136, an operation matching module 138, a cost basis selector 140, and a report generator 142. The setting platform 120 may be communicatively connected to a third-party server(s) 150 that can provide an additional source of external data. For illustration purposes, the setting platform 120 may be a cost basis setting platform that can facilitate a generation of cost basis financial report to the subscriber. Each component or module of the FTPC server 104 can be realized in hardware, software, or a combination thereof. For example, the web-sockets 108(1)-108(4) may be implemented by a software module(s) designed to facilitate communications between the FTPC server 104 and the external data 102.

The external data 102 may include financial transaction data involving assets owned, purchased, sold, traded, received, given, or transacted to and by a subscriber (not shown) on a blockchain-based financial transaction or off a blockchain. The assets may include any other property that is quantifiable and associated with an economic value. In some examples, the assets may include digital assets or cryptocurrency, tokens, NFTs or the like. The external data 102 may include external data that can be stored in the FTPC server 104 and further processed to generate a financial report(s) to a requesting subscriber.

Blockchain data 102(1) (e.g., Bitcoin, Ethereum, etc.) may include blockchain-based financial transaction data where the transaction data can be stored in blocks validated by participating nodes, linked to each other, thereby creating a chain of immutable interconnected data entries. Immutability in blockchain may mean that no information that is included in the data of the blocks can be changed without being detected. The information may be managed by a set of decentralized nodes, removing the need for a central authority to validate the transactions. In some instances, the blockchain data 102(1) may be a distributed ledger of transactions in chronological order, or may be presented in any order that may be suitable for use by a blockchain network. For example, the transactions recorded in the blockchain may include a destination address and a currency amount, such that the blockchain records how much currency is attributable to a specific address. Additional information may also be captured such as a source address, timestamp, and the like.

Exchange exported data 102(2) may include data from cryptocurrency exchange entities where coins such as Bitcoin, Ethereum, Solana, and the like, can be bought, sold, or traded. In one example, the exchange exported data 102(2) may include traded, bought, sold, etc. cryptocurrency by the subscriber during a particular time period. In this example, the exchange exported data 102(2) that may be transmitted to the FTPC server 104 can include associated transaction fees and other fees that relate to the buying, selling, or swapping of the cryptocurrency. For clarity, the “Exchange” can be a centralized or decentralized entity and includes digital asset exchanges like Coinbase and Binance, but also decentralized exchanges (like Uniswap) or other entities like custody providers (e.g. BitGo), staking services, “Over the counter” (OTC) exchange providers etc.

Customer supplied data 102(3) may include financial transaction data from direct trading or personal transactions by the subscriber and can be directly transmitted to the FTPC server 104. The customer-supplied data 102(3) may also include financial data such as transaction fees, expenses, and other data that may be used in generating the financial report as described herein. In one example, the customer-supplied data 102(3) may include peer-to-peer (P2P) cryptocurrency trading, transaction fees and expenses associated with the P2P cryptocurrency trading, and the like. Another example of customer-supplied data is “meta data” about specific digital asset wallets and exchanges. For example, this can include the “geographical” or “jurisdictional” location of a specific wallet or transaction or notes. Because there are many different ways a digital asset can enter or leave a digital asset wallet, each way may be identified, classified and stored as transaction information on the atomic level in the customer-supplied data to allow, e.g., accurate accounting treatment as described herein.

External reference and metadata 102(4) may include historical transaction or market prices such as prices of the assets at different time periods, different exchange sources, or a combination thereof, that can be used as a reference for the assigning of values to the asset: and other similar information.

The above examples of external data 102 are non-limiting and may include other financial transaction data from other external sources having trading platforms that can be linked to the FTPC server 104. One such example is a trading desk linking its trading platform to the FTPC server 104, allowing trades to be captured in the system as they occur. The transaction data from each of the external data 102 may be received and stored by the FTPC server 104 via the network 106. The stored transaction data may include associated metadata such as, but not limited to, a subscriber ID, source ID, transaction ID, type of cryptocurrency, timestamps for each transaction, subscriber financial account ID, destination node ID, and other similar information. In one embodiment, the external data 102 may be continuously processed to generate output data that can include financial reports or financial report notification alerts that the subscriber subscribed to receive. In other embodiments, the pre-processing of the external data 102 may be triggered by a detection of an event such as receiving of a subscriber request or loading of new data. Alternatively, or additionally, the pre-processing of the external data 102 may be performed at a regular interval such as every minute, hour, etc.

The network 106 may be, without limitation, a local area network (“LAN”), a larger network such as a wide area network (“WAN”), a carrier network, or a collection of networks, such as the Internet. Protocols for network communication, such as TCP/IP, may be used to implement the network 106. The network 106 may provide telecommunication and data communication in accordance with one or more technical standards. While the third-party server(s) 150 are not shown to connect through the network 106, the FTPC server 104 may access the third-party server(s) 150 via the network 106 or other communication mediums.

Each one of the web-sockets 108(1)-108(4) may include an endpoint of a two-way communication link between two programs running on the network 106. The endpoint includes an Internet Protocol (IP) address and a port number that can function as a destination address of the web-socket. Each one of the web-sockets 108(1)-108(4) is bound to the IP address and the port number to enable external entities such as the blockchain data 102(1), exchange exported data 102(2), customer supplied data 102(3), and external reference and meta data 102(4) to communicate with the FTPC server 104. In one example, the web-sockets 108(1)-108(4) may be set up to receive external data streams from the blockchain data 102(1), exchange exported data 102(2), customer-supplied data 102(3), and external reference and meta data 102(4), respectively. The received external data streams may be pushed to the queue 110 before they are decoupled, via the data parser module 112, and stored into the database 114.

In one example, the decoupled external data streams may include the data streams that the database 114 has subscribed to receive via a publish/subscribe mechanism of the queue 110 (e.g., as provided by APACHE® KAFKAR). For example, the decoupled external data streams may include blockchain-based financial transaction data at a particular time period, type of cryptocurrency, subject of the transaction, or a combination thereof, for example. In this example, database 114 may subscribe to receive the external data streams via the queue 110. As described herein, the decoupling of the external data streams may include independently retrieving and processing the data streams without affecting the continuity or configuration of the external data streams that may be continuously received via the queue 110.

In one embodiment, the data parser module 112 may transform the decoupled external data streams to conform with a schema structure (e.g., JSON-like storage) of the database 114. The data parser module 112 may filter log entries, search for data and patterns in files of various data formats, convert log files from one data format to another data format such as the data format that is supported by MongoDB, and the like. In some instances, the data parser module 112 may identify details of the decoupled external data streams and can associate corresponding financial actions to the identified decoupled external data streams from the queue 110. The association may be based upon the details of the decoupled data streams that can include, without limitation, detected changes (deltas) in a subscriber's bank account or accounts managed directly on the blockchain by Decentralized Finance (“DeFi”) protocols, increase or decrease in the number of assets, asset identification, transaction IDs, source node IDs, destination node IDs, timestamps, ID for a type of transaction, identification of parties, and similar information. For example, a trade action may be associated with a parsed transaction data related to a detected decrease in a subscriber's dollar account and an increase in number of assets in between states. In this example, the state of the asset before and after transition may be used as a reference to generate, e.g., a BuyOp for the parsed transaction data. In another example, the trade action in the parsed transaction data may relate to a detected increase in a subscriber's dollar account and a decrease in number of assets in between states. In this other example, the state of the asset before and after the transition may be used as a reference to generate, e.g., a SellOp for the parsed transaction data.

The database 114 may include a document-based non-relational database management system that can store the parsed transaction data via the data parser module 112. In one embodiment, the database 114 may include a non-relational document database that provides support for JSON-like storage. For example, the non-relational document database may store data objects in collections and documents instead of tables and rows in traditional relational databases. In this example, the collections may include sets of documents, which may be akin to tables in the relational database while the documents can consist of key-value pairs as the basic unit of data. For instance, for a particular transaction data, the database 114 may store the transaction ID which can be an action ID, associated atomic primitive operation ID, source ID, destination ID, subject of transaction ID, type of transaction ID, bank account ID, and the like. In this instance, the associated atomic primitive operation ID may be utilized by the FTPC server 104 as a reference to identify the atomic primitive operations to be generated and matched for purposes of generating the financial report as described herein. The FTPC server 104 may further utilize the associated atomic primitive operation ID to track the requested transaction data that can be processed to generate the financial report. In some instances, the atomic primitive operations need not be associated and the FTPC server 104 may generate the operations based upon specified logic of the queried transaction data.

The setting platform 120 may include an example application that processes the stored financial data in the database 114 to generate the financial report or financial report notification alert that the subscriber subscribed to receive. In one example, the setting platform 120 may generate the financial report that can be used to determine a favorable taxable income for the subscriber. In this example, and to generate the financial report, the setting platform 120 may be configured to perform the querying of stored financial transactions in the database 114 and processing of the queried financial transaction data to generate the content for the financial report.

In one example, the setting platform 120 may facilitate the matching between the generated atomic primitive operations, application of atomic primitive operations such as an application of the AdjustOp to the BuyOps to calculate the cost basis, or a combination thereof, to generate the financial report. In this example, the setting platform 120 may decompose an action into pre-established atomic primitive operations (e.g., financial primitives) and implement matching of the atomic primitive operations across the appropriate actions for every asset related to the queried transaction data. That is, operations may be generated and matched by the setting platform 120 irrespectively of which report is requested. For example, the platform may match “producing” operations such as BuyOp or BorrowOp with “consuming” operations, such as SellOp, PaybackOp, or DiscardOp. USD operations such as USDEarnOp and USDReceiveOp are not generally appropriate to match. AdjustOp can be considered a “meta” operation (e.g., acting on BuyOps and SellOps) and would generally not be matched. By way of illustration, the generating of reports such as a sales profit and loss (PnL) report can be facilitated by scanning SellOps, checking corresponding matching BuyOps, and subtracting the cost basis (stored in the BuyOps) from the proceeds (stored in the SellOps), for example.

The data query module 130 may include an application that can retrieve the corresponding financial transaction data from the database 114. The querying and retrieval may be performed continuously, over a periodic interval, or upon a triggering event such as the receiving of the subscriber request. The continuous retrieval and pre-processing of the retrieved transaction data may be implemented to send notification alerts without initial or received interactions from the subscriber. In some cases, the retrieved transaction data may be defined by parameters of the notification alerts that the subscriber has subscribed to receive. For example, the parameters can include every transaction action, the transaction actions entered into by the subscriber over a particular period, type or subject of the transaction action, source of external data, or a combination thereof.

With the queried financial transaction data, the price value representation 132 may be configured to assign prices or values to the queried financial transaction data and particularly to the one or more assets that are involved in the action in the queried financial transaction data. In one example, the database 114 may store the timestamps or time of transactions involving the one or more assets in the queried transaction data. In this example, the assigning of values may be based upon the prices of the assets at the time of the transaction such as at the time of buying of the asset, selling of the asset, and the like.

In one embodiment, the price value representation 132 may provide a consistent and transparent centralized validation table of value to time that can be used as a reference when assigning prices to the assets that are involved in the action. The centralized validation table 134 may store key-value pairs of prices for different types of assets at different time periods and US dollar exchange rate at the different time periods, for example. The stored information in the centralized validation table 134 may be utilized to provide consistent pricing of the assets involved in the action at the time of the transaction. For example, a trade action from the queried transaction data may involve an asset that was sold on Jan. 10, 2022. In this example, the centralized validation table 134 may be used to determine the value of the asset at that time, i.e., on Jan. 10, 2022.

The operation generator module 136 may be configured to generate the atomic primitive operations that can be used to generate the content for the financial reports. In one embodiment, the atomic primitive operations may by generated from the action or actions that are associated with the queried financial transaction data. The generated atomic primitive operations may include the buying of an asset operation (referred to as a BuyOp), selling of the asset (referred to as a SellOp), borrowing of the asset (referred to as a BorrowOp), paying back debt in an account (referred to as a PaybackOp), discarding of the asset as if nothing is received (referred to as a DiscardOp), adjusting of cost basis or sale proceeds (referred to as an AdjustOp), earning or losing an amount (positive or negative) of USD (referred to as USDEarnOp, representing a taxable gain (loss)), and/or receiving USD (referred to as USDReceiveOp, representing a non-taxable receipt of USD). Here, the operation generator module 136 may apply preconfigured rules corresponding to financial semantics or specified logic of the actions associated the transaction data to identify the atomic primitive operations to be generated. For example, a DebtAction that may represent borrowing by a subscriber may generate a BorrowOp that can be used as a reference to facilitate generation of a debt report. In this example, and in a case where the subscriber executed a short sale, the generated BorrowOp can be matched with the SellOp and this link can facilitate the generation of the PnL report.

With the generated one or more atomic primitive operations, the setting platform 120 may identify the generated atomic primitive operation(s) that can be matched with another atomic primitive operation(s), linked with another operation(s), or a combination thereof. In identifying the matching pairs, for example, the operation matching module 138 may store a table of preconfigured pairs of matching atomic primitive operations such as between the generated BuyOp and the generated SellOp; BorrowOp and the PaybackOp; BorrowOp and the SellOp; BuyOp and the PaybackOp; BuyOp and the DiscardOp; and the associated BorrowOp and the associated DiscardOp. Each of these pairings may be retrieved from the table (not shown) and used as a reference when identifying the generated atomic primitive operations to be matched or linked with one another.

For example, a SellOp and a BuyOp may be generated from the action that is associated with a queried trading action. Based on the stored preconfigured pairings, the SellOp and the BuyOp may be matched and associated with the trading action in the database 114. Further, the AdjustOp may be applied to the BuyOp and the SellOp to adjust cost basis and proceeds, respectively. In this example, the link between the AdjustOp and the BuyOp/SellOp may be stored in the database 114 to allow tracing back of original (or unadjusted cost or proceeds) to justify the adjusted cost basis or proceeds. In one instance, the AdjustOp from a FeeAction (or fee payment action) may be linked to the BuyOp. In this case, the paid fees for the FeeAction may be used as a reference to justify the adjusted cost basis of the BuyOp. The links between the BuyOps and the SellOps (on one side) to the AdjustOps (on the other side) may be many-to-many i.e., a single BuyOp or SellOp can be adjusted multiple times by linking it to multiple AdjustOps, and one AdjustOp can adjust multiple BuyOps and/or SellOps.

In the preceding example, the cost basis selector 140 may include an example application that facilitates an adjustment in cost basis or proceeds in the trading action and further link the adjustment operation (AdjustOp) to the BuyOp/SellOp components of the trading action. Further, the cost basis selector 140 may facilitate a determination of an optimal adjusted cost basis to utilize that is favorable to the subscriber. For example, the cost basis selector 140 may determine an optimal (or near-optimal) assignment of asset lots for specific identification on every sale operation. In another example, the cost basis selector 140 may determine or calculate the adjusted cost basis for each of the FIFO, LIFO, and other cost basis methods, compare the determined adjusted cost basis from each of these cost basis methods, and select the cost basis method that can generate the optimal adjusted cost basis that is favorable to the subscriber. The optimal adjusted cost basis may include the adjusted cost basis that generates a minimum taxable income.

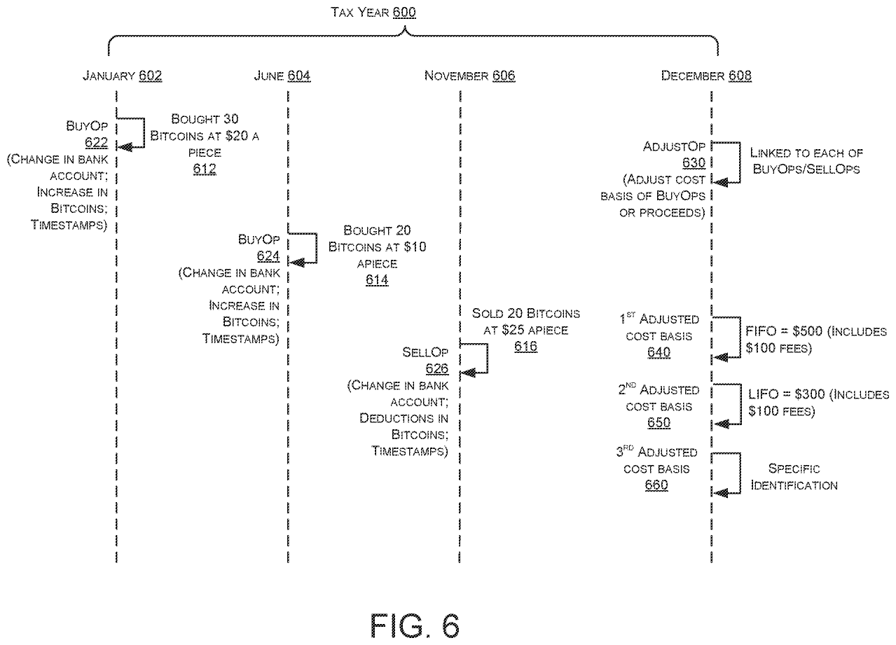

The FIFO cost basis method may include an asset-management and valuation method in which assets produced or acquired first are sold, used, or disposed of first. For tax purposes, the FIFO cost basis method assumes that assets with the oldest costs are included in the income statement's cost of goods sold (COGS). The remaining inventory assets may be matched to the assets that are most recently purchased or produced. Here, the generated atomic primitive operations may be located in a data structure that is defined by the implementation of the FIFO cost basis method. On the other hand, the LIFO cost basis method is an accounting method in which assets purchased or acquired last are disposed of first. The FIFO and LIFO cost basis methods are further illustrated in detail in FIG. 6 below.

While the financial reporting in the preceding example is based upon the matching between the BuyOp and the SellOp, other types of matchings may be applied to generate the financial report. As one, non-limiting example, a pairing between an associated BorrowOp and DiscardOp may be used as a reference to generate accrued interest.

The report generator 142 may generate a financial report or financial report notification alert to the subscriber upon the processing of the transaction data. In one example, the financial report may include a profit and loss statement, fees report, debt report, holdings report, and the like. Entries in the report(s) may be taken from the results of the actions described herein.

The third-party server(s) 150 may provide additional sources of external data that can be retrieved and/or processed as described above. In some cases, the third-party server(s) 150 may provide an additional database similar to the database 114 in the FTPC server 104.

### Example Processing Flow for Storing of External Data to the Database

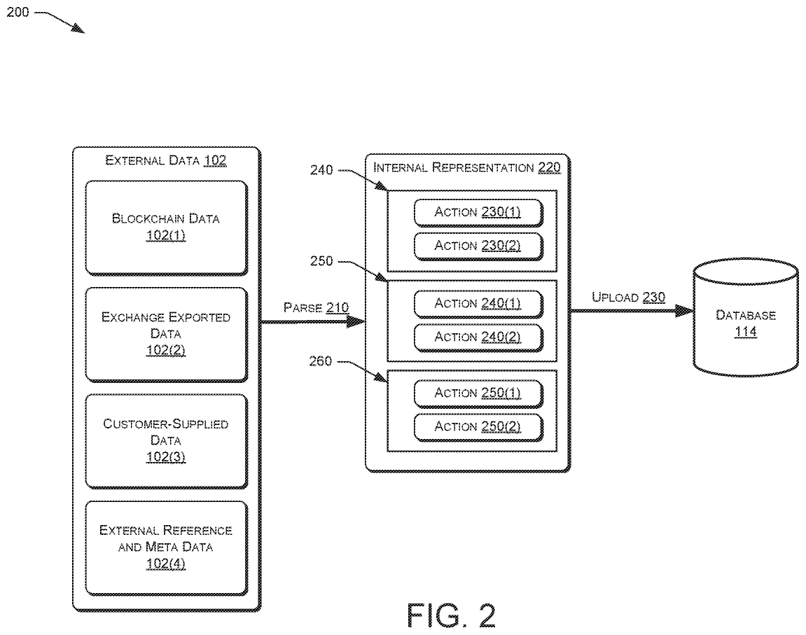

FIG. 2 illustrates a block diagram 200 that shows a receiving and storing of an internal representation of the external data 102 to the database 114. The block diagram 200 may be implemented by the FTPC server 104 in FIG. 1 and particularly, by the data parser module 112.

In one embodiment, the data parser module 112 may parse 210 the external data 102 to generate an internal representation 220 of the received external data or financial data transactions from the different sources or exchanges. Upon parsing of the external data 102, the FTPC server 104 may further upload 230 the derived internal representation 220 as transaction data to the database 114.

For example, data parser module 112 may transform the blockchain data 102(1), exchange exported data 102(2), customer-supplied data 102(3), and/or external reference and meta data 102(4) to conform with a schema structure (e.g., JSON-like storage) of the database 114. In this example, the data parser module 112 may filter log entries, search for data and patterns in files of various data formats, and/or convert log files from one data format to another data format such as the data format that is supported by MongoDB. In one instance, the internal representation 220 may include a first transaction 240 with associated actions 240(1)(2), a second transaction 250 with associated actions 250(1)(2), and a third transaction 260 with associated actions 260(1)(2). Each of the first transaction 240, second transaction 250, and the third transaction 260 may include metadata such as transaction data ID, timestamps for their respective actions, source ID, destination ID, ID for associated atomic primitive operations, and the like.

In one embodiment, each of the actions in the internal representation 220 may include one of a trading action such as selling and buying assets, a discarding action such as donating the asset, a minting action such as receiving an airdropped asset, a depositing or withdrawing action (to/from an account), debt action such as borrowing or paying back an asset, fee action representing fees incurred during a financial activity (e.g., trading fees), asset transfer action representing sending or receiving an asset (such as between a company's own subsidiaries), and the like. Further, each of these actions may be further decomposed into one or more atomic primitive operations, which can be representative of the generated components of the action.

In an embodiment, the uploading of the internal representation 220 may include storing of the transaction data in a particular format such as that of MongoDB which stores data in BSON format. In this embodiment, the database 114 may include a document-based non-relational database management system that can store the uploaded internal representation 220 in the desired particular format. For example, the database 114 may store data objects in collections and documents instead of tables and rows in traditional relational databases. In this example, the collections may include sets of documents, which may be akin to tables in the relational database while the documents can consist of key-value pairs as the basic unit of data. In one instance, and for a particular transaction data, the database 114 may store the transaction ID, associated atomic primitive operation ID, source ID, destination ID, subject of transaction ID, type of transaction ID, bank account ID, geographical identifier ID and the like.

### Example Processing Flow for Generating the Financial Report

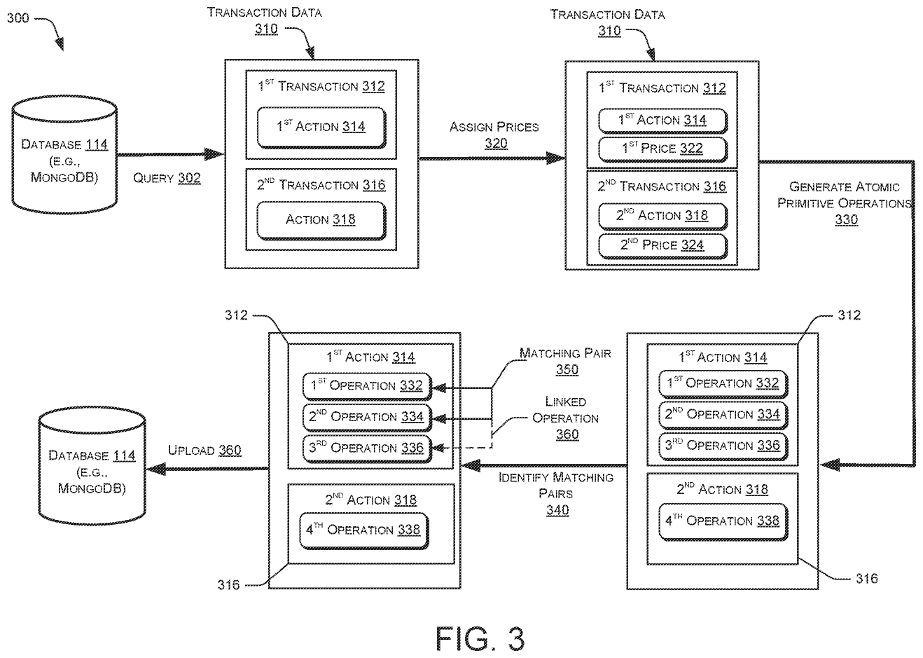

FIG. 3 illustrates a block diagram 300 that shows an example implementation for pre-processing transaction data to facilitate generation of a report. In one embodiment, the pre-processing of the transaction data may be made in multiple passes to construct an accurate model of a financial state of the subscriber at different periods. Here, the atomic primitive operations may be generated and matched regardless of type of report to be requested or generated for the subscriber. In another embodiment, the pre-processing of the transaction data may be triggered by an event such as receiving of a subscriber request for a particular report. For purposes of illustration, the discussion below facilitates the generation of the report in response to a subscriber request for a calculation of the taxable income over a particular action such as a trading action.

In one embodiment, the FTPC server 104 may perform a query 302 on the database 114 to retrieve transaction data 310, which includes a first transaction 312, a first action 314, a second transaction 316, and a second action 318. For example, the first action 314 and the second action 318 may include a trading action and a burn action, respectively. The burn action may include disposing of the asset without consideration e.g., donation. In this example, the first transaction 312 and the second transaction 316 may include metadata and other information of the first action 314 and the second action 318, respectively.

The FTPC server 104 may then assign prices 320 to the first action 314 and the second action 318. Particularly, prices or values are assigned over the assets that are involved in the first action 314 and the second action 318. Here, a first price 322 may include the assigned value of the involved assets in the first action 314 at the time of the corresponding transaction while a second price 324 may include the assigned value of the involved assets in the second action 318 at the time of the corresponding transaction. With the assigned prices to each asset in the transaction data 310, the FTPC server 104 may generate atomic primitive operations 330 from the corresponding actions in the retrieved transaction data 310. In one embodiment, the generated atomic primitive operations may be taken from the associated atomic primitive operations in the queried transaction data, referenced from stored preconfigured atomic primitive operations such as an adjusting operation (AdjustOp), or a combination thereof. For example, the first action 314 may be associated with a generated first atomic primitive operation 332 (BuyOp), second atomic primitive operation 334 (SellOp), and a third atomic primitive operation 336 (AdjustOp) while the second action 318 can be associated with a generated fourth atomic primitive operation 338 (DiscardOp). In this example, the first atomic primitive operation 332 (BuyOp), second atomic primitive operation 334 (SellOp), and the third atomic primitive operation 336 (AdjustOp) may be among the atomic primitive operations that are generated to effect the first action 314 on the queried transaction data 310 while the generated fourth atomic primitive operation 338 (DiscardOp) can be generated to effect the second action 318. In some embodiments, the first atomic primitive operation 332 (BuyOp) and the second atomic primitive operation 334 (SellOp) may be referenced from the atomic primitive operations that are associated from the queried transaction data 310 while the third atomic primitive operation 336 (AdjustUp) and the fourth atomic primitive operations 338 (DiscardOp) can be referenced from the stored preconfigured set of atomic primitive operations.

In one embodiment, the FTPC server 104 may use the table of preconfigure matching in the operation matching module 138 to identify matching pairs 340 among the generated atomic primitive operations in the first action 314, second action 318, or a combination thereof. For example, to calculate the taxable net income for the trading action, a matching pair 350 is representative of the matching between the first atomic primitive operation 332 (BuyOp) and the second atomic primitive operation 334 (SellOp) to generate an income value. In this example, a linked operation 360 may indicate the linking of the third atomic primitive operation 336 (AdjustOp) to adjust the cost basis and the proceeds for first atomic primitive operation 332 (BuyOp) and the second atomic primitive operation 334 (SellOp), respectively. With this adjustment, the linked operation 360 may facilitate the calculation of the taxable net income for the trading action (first action 314).

In one example, the location of the first atomic primitive operation 332 (BuyOp) and the second atomic primitive operation 334 (SellOp) in the data structure may be determined in accordance with the cost basis method (e.g., FIFO) that is currently being applied to determine the taxable income. In some cases, a specific identification method may be used to identify the assets and/or operations to be used in calculating the taxable income. For example, the specific identification method may be used to find an optimal or near optimal assignment of asset lots on every sale.

With the calculated taxable income in the preceding example, the FTPC 104 may upload 360 the results of the matching operations to the database 114. For example, the results may include the calculated taxable income for the first action 314 (trade action) and the amount and value of the lost asset in the second action 318 (burn action). In this example, the results may be included in the content of the financial report to be sent to the subscriber.

Example Action Involving Assets from Blockchain-Based-Financial Transactions

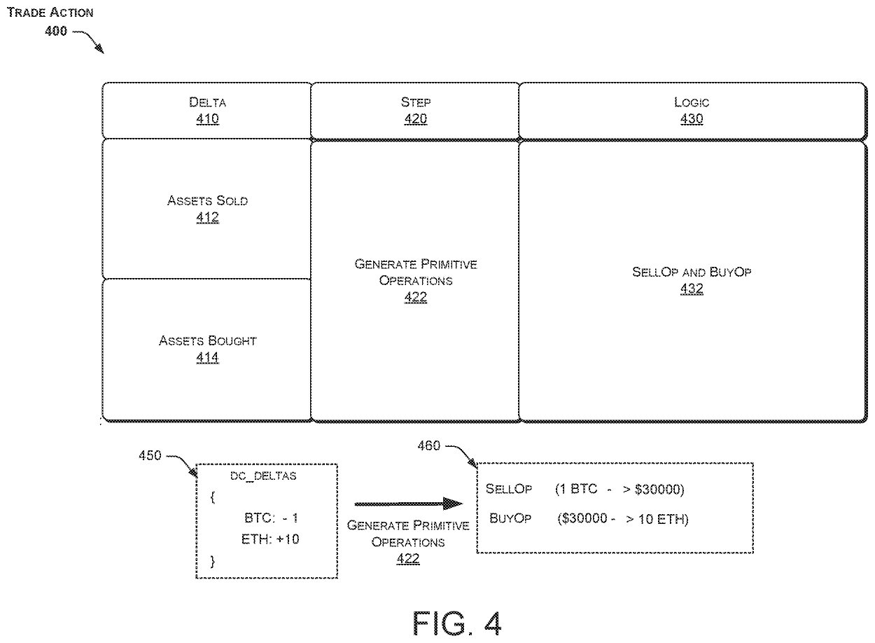

FIG. 4 illustrates a block diagram of an example trade action 400 that includes selling and buying of assets over a particular time period. As shown, the trade action 400 may include a delta 410 that represents changes in assets sold 412 and assets bought 414, a step 420, and a logic 430. The step 420 may represent the pre-processing from the storing of the transaction data to the matching process to generate the financial report as described in FIG. 3 above. In order to generate the atomic primitive operations, the FTPC server 104 may make multiple passes over the same transactions in order to construct an accurate model of the financial state of the subscriber at different points in time.

In one example, the trading action 400 may include selling 1 Bitcoin for $30,000 and buying 10 ETH for $30,000 as shown in representative block 450. Here, the step 420 for the trade action 400 may generate primitive operations 422 that can include BuyOps and SellOps, which are represented by block 432. These atomic primitive operations may be derived from the details of the assets sold 412 and the assets bought 414. In this example, the trading action 400 may generate the SellOp and BuyOp as shown in representative block 460. The generated atomic primitive operations in the representative block 460 may be combined (i.e., selling price minus buying price) to generate a gross income, for example. In this example, another atomic primitive operation such as the AdjustOp may be generated and linked to adjust the cost basis and the proceeds for the BuyOp and the SellOp, respectively, in the trading action 400.

The trade action 400 is for illustration purposes only and other, different actions as described herein may involve corresponding changes in the delta 410 and generated primitive operations 422.

For example, a mint action (not shown) may correspond to an increase in an asset's balance indicated by a positive delta 410. The positive changes may represent earnings via e.g. mining, validator income, airdrops, or yield generation. In this example, the generated atomic primitive operations may include USDEarnOp and/or BuyOp (e.g., with a pre-adjusted cost basis of $0).

For another example, a burn action (not shown) may correspond to a decrease in an asset's balance indicated by a negative delta 410. The negative changes may represent irrevocable loss of an asset. In this example, the generated atomic primitive operations may include SellOp with zero proceeds or USDEamOp, which can be an atomic primitive operation indicating a gain or loss of USD and should be treated as a tax event).

For example, the burn action/discard (not shown) may correspond to a decrease in an asset's balance indicated by a negative delta 410. The negative changes may represent the disposition of the asset without consideration. In this example, the generated atomic primitive operations may include DiscardOp.

For example, a fee action (not shown) may correspond to a decrease in asset balances indicated by a negative delta 410. The negative changes may represent payment of a transaction fee. In this example, the generated atomic primitive operations may include DiscardOp and AdjustOP, and so on.

### Example FTPC Server

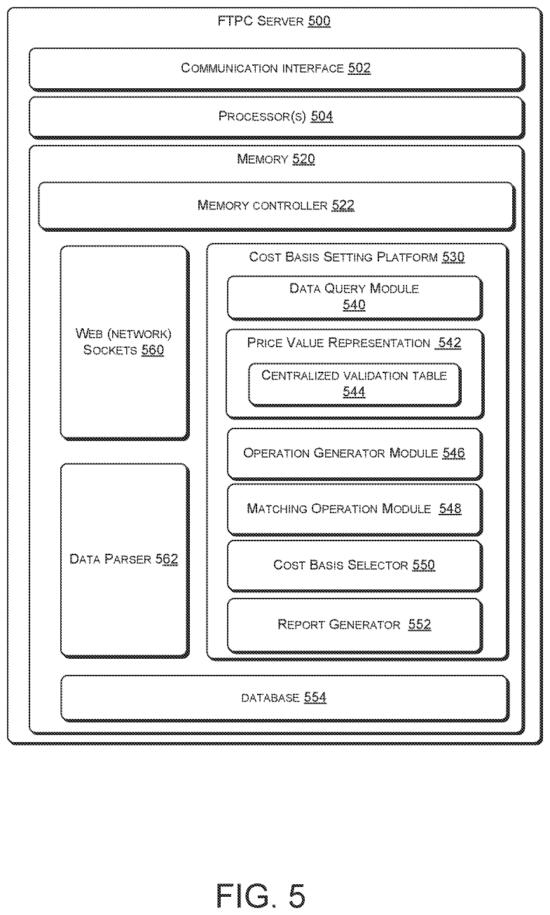

FIG. 5 is a block diagram of an example FTPC server 500 that implements, for example, the improving of the cost basis calculation based on atomic primitive operations. The FTPC server 500, which may be similar to the FTPC server 104 of FIG. 1, may include a computer system that receives external data, processes the received external data, and generates a financial report or financial report notification alert to the subscriber.

The FTPC server 500 may include a communication interface 502 that facilitates communication with the external data 102. Communication between the FTPC server 500 and other electronic devices may utilize any suitable sort of communication protocol for sending and receiving data and/or voice communications.

The FTPC server 500 may further include a processor 504 having electronic circuitry that executes instruction code segments by performing basic arithmetic, logical, control, memory, and input/output (I/O) operations specified by the instruction code. The processor 504 can be a product that is commercially available through companies such as Intel® or AMD®, or it can be customized to work with and control a particular system. The processor 504 may be coupled to other hardware components used to carry out device operations. The other hardware components may include one or more user interface hardware components not shown individually-such as a keyboard, a mouse, a display, a microphone, a camera, and/or the like-that support user interaction with the FTPC server 500.

The FTPC server 500 also may include memory 520 that stores data, executable instructions, modules, components, data structures, etc. The memory 520 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc-Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by modulated data signals, such as a carrier wave. In contrast, communication media may embody computer-readable instructions, data structures, program modules, or other data in a modulated data signal, such as a carrier wave, or other transmission mechanisms.

A memory controller 522 may be stored in memory 520 of the FTPC server 500. The memory controller 522 may include hardware, software, or a combination thereof, that enables the memory 520 to interact with the communication interface 502, processor 504, and other components of the FTPC server 500. For example, the memory controller 522 may receive external data streams from the communication interface 502 and facilitate storing of the received external data streams in memory 520. In another example, the memory controller 522 may retrieve data streams from memory 520 and the retrieved data streams can be processed in the processor 504.

The memory 520 may include a cost basis setting platform 530 that, when executed, implements the optimization of the cost basis calculation based on atomic primitive operations. As shown, the cost basis setting platform 530 may further include a data query module 540, price value representation 542 with a centralized validation table 544, an operation generator module 546, a matching operation module 548, a cost basis selector 550, and a report generator 552 that may respectively correspond to the cost basis setting platform 120, data query module 130, price value representation 132, centralized validation table 134, operation generator module 136, matching operation module 138, cost basis selector 140, and the report generator 142 of FIG. 1.

The memory 520 may further store and/or implement, at least in part, web-sockets 560, a data parser 562, and a database 570 that may respectively correspond to the web sockets 108, data parser module 112, and the database 114 of FIG. 1. In one example, each component of the memory 520 can be realized in hardware, software, or a combination thereof.

The web-sockets 544 may be implemented by a software module designed to establish communications with the external data 102. In one example, each of the web-sockets 544 is bound to the IP address and the port number to communicate with the corresponding external data source.

In one example, the data parser 562 may include an application programming interface (API) to establish a connection with the event streaming platform. The cost basis setting platform 530 of the FTPC server 500 may subscribe to blockchain data in the event streaming platform and utilize the data parser 562 to facilitate the storing of the blockchain data to the database 554. In this example, the blockchain data may be stored as a non-relational document database that can provide support for JSON-like storage, or similar document-based non-relational management system.

The FTPC server 500 may use the communication interface 502 to transmit financial report notification alert or receive a subscriber request. Here, the cost basis setting platform 530 may use the data query module 540 to query the transaction data when new external data is stored, continuously to generate the financial report notification alert to the subscriber, or upon receiving of a subscriber request. Upon retrieving of the transaction data, the cost basis setting platform 530 may utilize the price value representation 542 to assign price or pecuniary values to the assets that are involved in the action.

Similar to the discussion in FIGS. 1 and 3 above, the cost basis setting platform 530 may then use the operation generator module 546 to generate the atomic primitive operations, match the generated atomic primitive operations, and use at least the matched atomic primitive operations to generate the content for the financial report.

### Example Cost Basis Calculation

FIG. 6 is a swimlane diagram illustrating an example cost basis calculation over financial transactions (or trading actions) incurred by a subscriber in a tax year. In the example shown, a tax year 600 is a calendar year during which corresponding financial transactions were incurred by the subscriber. First, in January 602, the subscriber bought 30 Bitcoins at $20 apiece 612. In June 604, the subscriber bought 20 Bitcoins at $10 apiece 614. Then, in November 606, the subscriber sold 20 Bitcoins at $25 apiece 616. As illustrated, the financial transactions over January 602, June 604, and November 606 may correspond to the atomic primitive operations BuyOp 622, BuyOp 624, and SellOp 626, respectively. An AdjustOp 630 may be applied to each of these atomic primitive operations BuyOp 622, BuyOp 624, and SellOp 626 to adjust the cost basis for BuyOp and proceeds for the SellOp (e.g., to account for trading fees). Thereafter, an adjusted cost basis that may generate a minimum taxable income can be selected for income tax filing, for example.

In one example, the trading action and particularly, the trading action component—BuyOp 622 may be based upon changes in bank account, increase in number of Bitcoins, timestamps, etc. in the subscriber's account. Similarly, the trading action components—BuyOp 624 and the SellOp 626 may be based upon the details of the financial transaction data in between nodes in the protocol or workflow. The details may include changes in the assets sold or assets bought as described above.

In one embodiment, the requested financial report may include a favorable calculation of the subscriber's taxable income over the selling of the 20 Bitcoins in November 606. In this embodiment, the FTPC server 500 may link the AdjustOp 630 to each of the trading components—BuyOp 622, BuyOp 624, and SellOp 626 to adjust the cost basis for the BuyOp 622, BuyOp 624 and further adjust the proceeds for the SellOp 626. The linked AdjustOp 630 may belong, for example, to a particular action such as FeeAction that corresponds to calculation of transaction fees. With the adjusted cost basis and proceeds, the FTPC server 500 may then generate a first adjusted cost basis 640 based on a FIFO cost basis method, a second adjusted cost basis 650 based on a LIFO cost basis method, and/or a third adjusted cost basis 660 based upon specific identification. The specific identification may include preconfigured selection of an optimal or near-optimal assignment of asset location for every SellOp, for example.

Assuming that the fees associated with the BuyOp 624 and the SellOp 626 are the same (e.g., $100 amount of fees), the first adjusted cost basis 640 based on the FIFO cost basis method may be $500, which is derived from the cost of the 30 Bitcoins that were purchased on January 602 at $20 apiece plus the $100 fees (note that of the 30 Bitcoins purchased only 20 were sold, hence 20*$20+$100=$500). For the LIFO cost basis method, the second adjusted cost basis 650 may be $300 because the 20 Bitcoins were purchased on June 604 at $10 apiece and $100 fees are added to this purchase. Here, the FTPC server 104 may use the corresponding generated atomic primitive operations when calculating the first adjusted cost basis 640 and the second adjusted cost basis 650. For example, for the FIFO cost basis method, the FTPC server 104 may use the BuyOp 622 to be matched with the SellOp 626. For the LIFO cost basis method, the FTPC server 104 may use the BuyOp 624 to be matched with the SellOp 626.

Assuming that the cost basis generated by the FIFO cost basis method 640 is greater than the adjusted cost basis value that is generated by the use of the LIFO cost basis method 650, i.e., $500, then the FTPC server 500 may utilize the cost value of $500 as the cost basis for the sale 616 for the tax year 600 and thus, possibly reduce the tax liability of the subscriber.

### Example Implementation—Platform for Improving Cost Basis Calculation

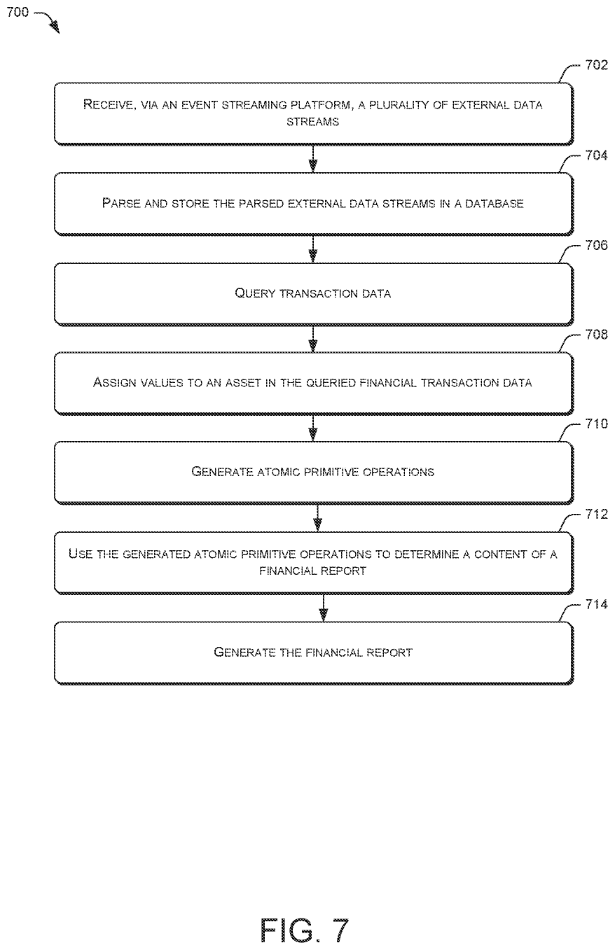

FIG. 7 is a flow diagram 700 that depicts an example process for at least one aspect of the techniques for implementing the platform for improving a cost basis calculation based on atomic primitive operations. In the following discussion of FIG. 7, continuing reference is made to the elements and reference numerals shown in and described with respect to the FTPC server of FIGS. 1 and 5. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 702, the FTPC server 500 may receive a plurality of external data streams from the external data 102. In one example, the queue 110 includes an event streaming platform that receives packets of external data streams encoded in JSON, XML or other structured data modeling language. The external data streams, for example, may include blockchain data 102(1), exchange exported data 102(2), customer supplied data 102(3), and/or external and meta data 102(4).

At block 704, the FTPC server 500 may parse and store the parsed external data streams in the database. For example, the data parser module 112 may transform the decoupled external data streams to conform with a schema structure of the database 554. In this example, the internal representation of the external data is stored in a particular format in the database 554.

At block 706, the FTPC server 500, via the data query module 540, may query and retrieve transaction data. In one embodiment, the FTPC server 500 may continuously query and retrieve the transaction data for processing. In a case where a particular transaction data is missing data, then the FTPC server 500 may use placeholders for additional data that can be requested from the subscriber. In another embodiment, the FTPC server 500 may query and retrieve the transaction data that correspond to the financial report notification alert to be forwarded to the subscriber. Here, the retrieved transaction data may include the actions that correspond to financial report notification alert to be transmitted to the subscriber. In various embodiments, the FTPC server 500 may query and retrieve the transaction data for processing based upon parameters of a received subscriber request. For example, the parameters may include, without limitation, the particular time period, type of transaction, subject of transaction, assets involved, or a combination thereof. In this example, the receiving of the subscriber request may trigger the querying and retrieving of the transaction data.

At block 708, the FTPC server 500, via the price value representation 542, may assign price values to the queried financial transaction data and particularly to the one or more assets that are involved in the action or blockchain-based financial transaction.

At block 710, the FTPC server 500 may generate atomic primitive operations. In one example, the FTPC server 500 may generate the atomic primitive operations that represent financial activity in the action based on the action's specified logic. In this example, the FTPC server 500 may store and associate the generated atomic primitive operations to the action.

At block 712, the FTPC server 500 may use the generated atomic primitive operations to determine the content of the financial report. For example, a matched pair of the generated atomic primitive operations (e.g., BuyOp and SellOp) may be used to generate a gross income for a particular traded asset.

At block 714, the FTPC server 500 may generate the financial report.

### Example Implementation—Selecting Adjusted Cost Basis Value

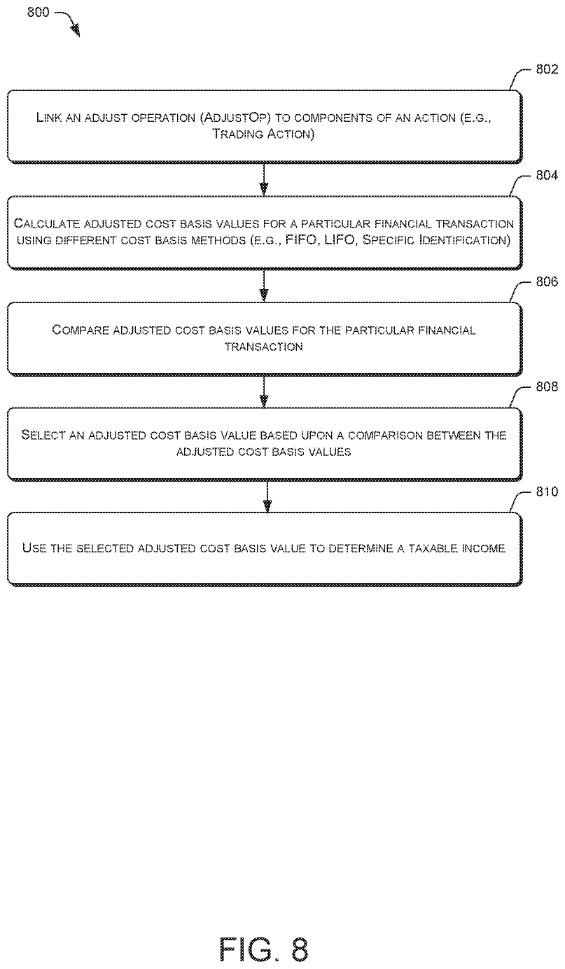

FIG. 8 is a flow diagram 800 that depicts an example procedure for at least one aspect of the techniques for selecting the adjusted cost basis value that can be used to determine, for example, a capital gain resulting from a transaction. In the following discussion of FIG. 8, continuing reference is made to the elements and reference numerals shown in and described with respect to the FTPC server of FIGS. 1 and 5. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 802, the FTPC server 500 may link an AdjustOp to components of an action. For example, the action is a trading action having BuyOp and SellOp components. In this example, the links between the BuyOps/SellOps (on one side) to the AdjustOps (on the other side) are many-to-many. A particular BuyOp or SellOp may be adjusted multiple times by linking the BuyOp or SellOp to multiple AdjustOps. In some cases, a single AdjustOp may adjust multiple BuyOps and/or SellOps.

At block 804, the FTPC server 500 may calculate adjusted cost basis values for a particular financial transaction using different cost basis methods. For example, the subscriber purchased 30 Bitcoins for $20 each plus $100 total fees, then later purchased 20 additional Bitcoins for $10 each plus $100 total fees. Assuming that the subscriber sold 20 Bitcoins at $25 each, then the calculated adjusted cost basis values for this particular transaction may be selected via one of the cost basis methods (e.g., FIFO, LIFO, or specific identification).

For example, using the FIFO cost basis method, the adjusted cost basis value for the sold 20 Bitcoins in the above example may include the amount of $20 per Bitcoin plus the $100 total fees for a total adjusted cost basis value of $500. Using the LIFO cost basis method, the total adjusted cost basis value for the sold 20 Bitcoins in the above example may include the amount of $10 per Bitcoin plus the $100 total fees for the total adjusted cost basis value of $300. A specific identification may be further utilized to select the location of the asset that can be associated with the adjusted cost value.

At block 806, the FTPC server 500 may compare the adjusted cost basis values between the different cost basis methods. In the preceding example, and assuming that the specific identification may generate an adjusted cost basis value that is lesser than the FIFO cost basis method, then the FIFO cost basis method may be utilized because of the higher amount ($500) of adjusted cost basis value versus the LIFO cost basis method ($300).

At block 808, the FTPC server 500 may select the adjusted cost basis value based upon the comparison between the adjusted cost basis values from the different cost basis methods.

At block 810, the FTPC server 500 may use the selected adjusted cost basis value on a gross income. The gross income for the particular transaction may be taken from the sale proceeds of an asset minus the adjusted cost basis of its acquisition.

### Microservice-Based Platform Implementation

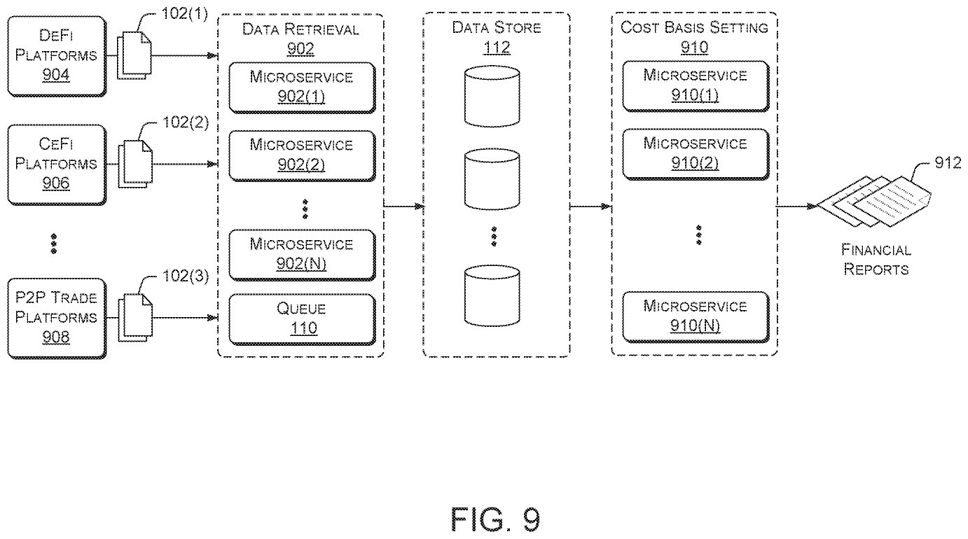

FIG. 9 illustrates a microservice-based implementation of the cost basis setting platform that generates financial reports. In various embodiments, the microservices as shown in FIG. 9 may be microservices that are associated with the cost basis setting platform 120, in which the microservices are loosely coupled. The microservices may communicate with each other via RESTful application program interfaces (APIs), in which the data exchanged by the microservices are stateless. In other words, each of the microservices does not depend on any previously stored context to process the current data from another microservice. The microservices of the cost basis setting platform 120 may be implemented via physical computer servers and/or in a computing cloud via a cloud service. The computing cloud may include a plurality of disaggregated servers that provide virtual application server functionalities and virtual storage functionalities. In various embodiments, a cloud service may be comprised of multiple physical computer servers which are disaggregated via a hypervisor. The physical computer servers each may have one or more processors, memory, I/O interface, and/or network interface. The cloud service may include a hypervisor that delegates calls to hardware in the underlying physical servers, and upon request generate a virtual machine from the separate portions of hardware, regardless of physical server. A virtual machine may host not only software applications, components including services, but also virtual web server functionalities and virtual storage/database functionalities.

In some instances, the virtual machines themselves may be further partitioned into containers, which enable the execution of a program in an independent subset of the virtual machine. Software such as Kubernetes™, Mesos™, and Docker™ are examples of container management software. Unlike virtual machines which may have a delay in startup due to provisioning of an entire operation system (OS), containers may be generated more quickly and on-demand since the underlying virtual machine is already provisioned. Accordingly, the cloud service may embody an abstraction of services. Common examples include service abstractions such as Platform as a Service (PAAS), Infrastructure as a Service (IAAS), and Software as a Service (SAAS).

The microservices that are associated with the platform 120 may include data retrieval microservices 902, such as the microservices 902(1)-902(N) that retrieve external data 102 from various data sources. The data sources may include the source data platforms 904-908. For example, the microservices 902(1)-902(N) may be used to obtain blockchain data 102(1) from DeFi platforms 904 (e.g., Uniswap and Aave), exchange exported data 102(2) from CeFi platforms 906 (e.g., Coinbase and BitGo), and customer-supplied data 102(3) from P2P trade platforms 908 or manual data entry processes. In some instances, the microservices 902(1)-902(N) may obtain the data via the application program interfaces (APIs) of the various platforms. The obtained data may be in various formats, such as a JavaScript Object Notation (JSON) format, a comma-separated values (CSV) format, or some other format. Accordingly, the microservices 902(1)-902(N) may include one or more microservices that perform data retrieval functions, data parsing functions, and/or so forth. For example, the data retrieval functions may include services that pull data from the source data platforms 904-908. Such services may perform functions such as scheduling periodic requests for data from the source data platforms 904-908, performing ad hoc requests for data for a source data platform in response to a manual input, and/or so forth. The data retrieval functions may also include functions that receive data from the data sources via a push model. For example, such functions may enlist with a data source platform to periodically receive data that is exported by a data source platform, cache the data received from a data source platform, receive notifications of data export from a data source platform, unenlist from receiving exported data from a data source platform, and/or so forth. The received data may be stored by one or more of the microservices 902(1)-902(N) in the receiving queue 110. In various embodiments, the receiving queue 110 may be an APACHE® KAFKA® intelligent queue.

In other examples, the data parsing functions that are performed by the one or more microservices 902(1)-902(N) may include a data conversion function, a query data file function, a data file status function, a load data file function, a store data function, and/or so forth. The data conversion function may convert a format of data files into other formats. For example, a data file in the CSV format may be converted into a JSON format, or vice versa. The query data file function may be used to query a data file for specific data and/or data with a specific format. The data file status function may be used to obtain a current status of a data file, such as whether the data file is received, waiting to be processed (e.g., reformatted), processed, or stored in a database. The load data file function may be used to load a specific data file for further processing and/or storage. The store data function may be used to store data from a data file in a database, such as the database 114. For example, the database 114 may include multiple data stores that are managed by MongoDB or another cross-platform decentralized document-oriented database program.

The microservices that are associated with the cost basis setting platform 120 may further include cost basis setting microservices 910, such as microservices 910(1)-910(N). In various embodiments, the data processing components of the platform 120 may be implemented as individual microservices of the microservices 910(1)-910(N). In some embodiments, each of the data query module 130, the price value representation 132, the operation generator module 136, the operation matching module 138, the cost basis selector 140, and the report generator 142 may be implemented as individual microservices of the microservices 910(1)-910(N). Accordingly, each of the microservices 910(1)-910(N) may perform functions that provide output data based on input data. The input data for each of the microservices 910(1)-910(N) may include data from the database 114 and/or data outputted by other microservices. The output data may include transaction actions, atomic primitive operations, cost basis values, financial report accounting entries, corresponding audit trail data, and/or so forth, that are processed and/or generated by the microservices 910(1)-910(N). For example, a microservice that handles report generation may perform functions that include generating financial reports 912 following data processing by one or more other microservices. The financial reports 912 may be generated by the microservice in response to specific queries or requests that are received by the microservice. For example, the queries or requests may include report requests, status queries, audit queries, and/or so forth. In some embodiments, the financial reports 912 may include accounting entries that conform to standardized accounting principles, such as the U.S. Generally Accepted Accounting Principles (GAAP), International Financial Reporting Standards (IFRS), and/or the like.

In other implementations, each of the one or more of the data processing components 130-142 of the cost basis setting platform 120 may be further decomposed into multiple microservices that perform one or more functions. However, in alternative implementations, the data processing components 130-142 of the platform 120 may be implemented as a single microservice instead of the microservices 910(1)-910(N).

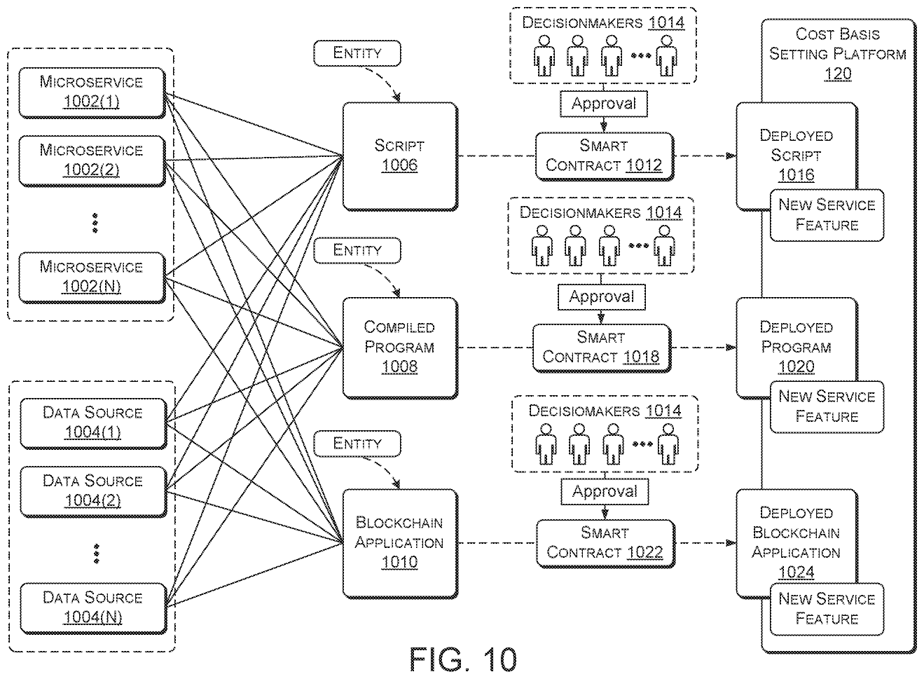

FIG. 10 is a block diagram illustrating the generation of candidate codes to provide new service features for a cost basis setting platform based at least on the microservices of the platform. The microservices 1002(1)-1002(N) may be microservices that are associated with the platform 120. The data sources 1004(1)-1004(N) may include data sources of data that may be relevant to the generation of the financial reports by the platform 120. Such data sources 1004(1)-1004(N) may include databases that are maintained by various parties, in which the databases are accessible to the platform 120 via APIs or other computer communication interfaces. For example, the data sources 1004(1) may include databases of financial service companies that provide financial services to various clients, such as the platforms 904-908. The data sources 1004(2) may include digital wallets, including for example those stored and managed on a blockchain as well as so called cryptocurrency wallets (which may be hardware, software or even analog processes and devices) that are used by users to store public and/or private keys of cryptocurrency transactions. The data sources 1004(3) may include databases maintained by financial applications used by various users, such as accounting applications, financial management applications, spreadsheet applications, tax preparation applications, and/or so forth.

In various embodiments, an entity that desires to add a new service feature to the platform 120 may leverage the microservice architecture of the platform 120 and one or more of the data sources 1004(1)-1004(N) to generate the new service feature for integration into the platform 120. As used herein, an entity may refer to an individual person, a member of an organization that operates the platform 120, a group of persons, a third-party organization, or some other group of individuals. The new service feature may be created using a script 1006, a compiled program 1008, or a blockchain application 1010. The new service feature may be generated to use the functionalities provided by one or more of the microservices 1002(1)-1002(N) and/or process data from the one or more data sources 1004(1)-1004(N). In order to facilitate the generation of new service features for the platform 120 by various parties, an organization that operates the platform 120 may publish (e.g., make publicly available) information related to the specifications and/or functionalities of the microservices 1002(1)-1002(N). For example, the organization may provide documentation on the microservices 1002(1)-1002(N) and their APIs via a publicly accessible website that is operated by the organization. Alternatively, the organization may make the APIs of the microservices 1002(1)-1002(N) of the platform 120 publicly accessible such that the functions of the microservices may be ascertained by third parties via dynamic discovery. Similarly, the organization may also publicly identify the data sources 1004(1)-1004(N), the data provided by the data sources 1004(1)-1004(N), and the API for accessing sets of data from the data sources 1004(1)-1004(N). For example, the organization may publish such information on the data sources 1004(1)-1004(N) on a publicly accessible website that is operated by the organization. In some instances, the publication of the information on the microservices 1002(1)-1002(N) and the data sources 1004(1)-1004(N) may be performed by a microservice of the platform 120.

With the respect to the script 1006, an entity may use a script editor application to generate code in the form of a script. The script may call one or more microservices 1002(1)-1002(N) via APIs and/or access data from one or more of the data sources 1004(1)-1004(N) to perform data processing. In some instances, the script may also encode some data processing functions that are to be performed in conjunction with the data processing provided by the one or more microservices of the platform 120. In some instances, the script 1006 may be a JavaScript that can be run by a JavaScript interpreter on a computing device equipped with processors and memory. For example, the script 1006 may be a script that is coded to request a financial report for a specific time period from the platform 120 and extract accounting entries from the report for population into a specific accounting application.

With the respect to the compiled program 1008, an entity may use an integrated development environment (IDE) to generate source code that is further compiled into a software application that is executable by processors and memory of computers or virtual machines. For example, the compiled program may be written using Java, Swift, or some other compiled programming language. The compiled program 1008 may call one or more microservices 1002(1)-1002(N) via APIs and/or access data from one or more of the data sources 1004(1)-1004(N) to perform data processing. In some instances, the compiled program 1008 may include additional data processing functions that are to be performed in conjunction with the data processing provided by the one or more microservices of the platform 120. The data processing functions of the compiled program 1008 may be more complex than those that are capable of being provided by the script 1006. For example, the compiled program 1008 may be configured to request a financial report for a specific time period from the platform 120, and then generate a reconciliation report that reconciles the account entries to financial data stored in a financial management software. Furthermore, the compiled program 1008 may offer more security, improved performance, and greater data processing efficiency than the script 1006.

The blockchain application 1010 may be coded by an entity in an IDE to execute in a blockchain execution environment that is executed by processors and memory of distributed servers or virtual machines. For example, the blockchain application 1010 may be a blockchain software application that is coded to execute in a distributed ledger platform environment, such as for example Ethereum, Bitcoin, or Hyperledger Fabric developed by IBM®. The blockchain application 1010 may be written using the Golang programming language, the Solidity programming language, the RUST programming language, or some other comparable programming language. Blockchain applications, such as the blockchain application 1010, are also referred to as smart contracts. In some instances, the blockchain application 1010 may be used to interact with the blockchain ledgers of the various DeFi platforms. For example, the blockchain application 1010 may be used to directly access and retrieve cryptocurrency transaction data from blockchain ledgers of multiple DeFi platforms. As such, the blockchain application 1010 may call one or more microservices 1002(1)-1002(N) via APIs and/or access data from one or more of the data sources 1004(1)-1004(N) to perform data processing. In some instances, the blockchain application 1010 may include additional data processing functions that are to be performed in conjunction with the data processing provided by the one or more microservices of the platform 120. Accordingly, in some embodiments, the script 1006, the compiled program 1008, or the blockchain application 1010 that provides a new service feature may be deployed for execution within the cost basis setting platform 120 of the organization once each is approved for deployment via a conventional process (e.g., approved via a board meeting, approved by a responsible officer or manager of the organization, etc.)

However, in additional embodiments, a smart contract, i.e., a blockchain application, may also be used to make and implement decisions by the organization, such as the addition of new service features into the platform 120. For example, an entity that coded the script 1006 for a new service feature may create a smart contract 1012 that enables the decisionmakers 1014 (e.g., members, stakeholders, partners, directors, and/or so forth) of an organization that operates the platform 120 to decide whether the new service feature is to be integrated into the platform 120. For example, the decisionmakers of a DAO may include members of the DAO. The decisionmakers of a centralized financial entity may be a board of directors. The entity may submit the compiled code of smart contract 1012 to one or more microservices of the platform 120, such that the one or more microservices may deploy the smart contract 1012 to a blockchain for execution by the blockchain execution environment. The one or more microservices of the platform 120 may further provide electronic notification (e.g., emails, text messages, etc.) to notify decisionmakers 1014 of the organization of the existence of the smart contract and the action to be taken with respect to the smart contract.

The smart contract 1012 may set out conditions for implementing the new service feature provided by the script 1006 into the platform 120. For example, the conditions may specify a period of time during which decisionmakers 1014 of the organization can vote to decide whether the implementation should occur, the minimum number of votes that constitute a quorum, the percentage of votes from the decisionmakers 1014 that constitutes an approving majority for the integration, and/or so forth. The smart contract 1012 may further provide a detailed explanation of the purpose and functionalities of the script 1006 and a link to a networked repository location where the script 1006 is located. The networked repository location may also provide a sandbox environment that includes dummy data, software applications, APIs of third-party applications, and/or so forth for which the script 1006 may be executed against to demonstrate the efficacy and utility of the script.

In some instances, the smart contract 1012 may specify that in case of approval by a majority of the decisionmakers 1014 of the organization, whether the new service feature provided by the script 1006 may be directly integrated into the platform 120 or integrated after further development by a designated software development team. The integration may include releasing the script 1006 into a designated network storage location for access and execution by users of the platform 120. In contrast, further development may include code review, code editing, code testing, code debugging, code rewriting, code refactoring, and/or so forth. In this way, the software development team may be employed to ensure that the script 1006 is error-free and can reliability provide the service features under various execution conditions. Accordingly, the smart contract 1012 may release the script 1006 to a predetermined network location such that script 1006 may be accessed by the development team. Following completion of further development, the development team may store the resultant script in a network storage location accessible by the smart contract 1012 such that the resultant script may be released for integration into the platform 120 by the smart contract 1012.

Since the smart contract 1012 is a blockchain application, the smart contract 1012 may provide application user interfaces that enable users to view information related to the smart contract 1012 and provide user input to the smart contract 1012. For example, a user may access the application user interfaces of the smart contract 1012 via a web browser or a dedicated client application. However, in alternative embodiments, the smart contract 1012 may use helper applications, such as oracles, to receive user input from users. Further, the smart contract 1012 may include application functionalities and logic algorithms that determine whether the conditions for the smart contract 1012 to implement the new service feature are fulfilled. Thus, assuming that the voting by the decisionmakers 1014 of organization satisfies the conditions of the smart contract 1012, i.e., the smart contract is approved by the decisionmakers 1014, the smart contract 1012 may self-execute to store the script 1006 or a refined version of the script 1006 into the designated network storage location as the deployed script 1016.

Likewise, an entity that coded the compiled program 1008 for a new service feature may create a smart contract 1018 that enables the decisionmakers 1014 (e.g., stakeholders) of the organization that operates the platform 120 to decide whether the new service feature is to be integrated into the platform 120. The smart contract 1018 may be deployed in a similar manner as the smart contract 1012 for voting by the decisionmakers 1014 of the organization. The smart contract 1018 may set out conditions for implementing the new service feature provided by the compiled program 1008 into the platform 120. For example, the conditions may specify a period of time during which decisionmakers 1014 of the organization can vote to decide whether the implementation should occur, the minimum number of votes that constitute a quorum, the percentage of votes from the decisionmakers 1014 that constitutes an approving majority for the integration, and/or so forth. The smart contract 1018 may further provide a detailed explanation of the purpose and functionalities of the compiled program 1008 and a link to a networked repository location where the compiled program 1008 is located. The networked repository location may also provide a sandbox environment that includes dummy data, software applications, APIs of third-party applications, and/or so forth for which the compiled program 1008 may be executed against to demonstrate the efficacy and utility of the program.

In some instances, the smart contract 1018 may specify that in case of approval by a majority of the decisionmakers 1014 of the organization, whether the new service feature provided by the compiled program 1008 may be directly integrated into the platform 120 or integrated after further development by a designated software development team. The integration may include releasing the compiled program 1008 into a designated network storage location for access and execution by users of the platform 120. In contrast, the further development may include performing code review, code editing, code testing, code debugging, code rewriting, code refactoring, and/or so forth with respect to the source code of the compiled program 1008. In this way, the software development team may be employed to ensure that the compiled program 1008 is error-free and can reliability provide the service features under various execution conditions. Accordingly, the smart contract 1018 may release the source code of the compiled program 1008 to a predetermined network location such that the source code may be accessed by the development team. Following completion of further development, the development team may store the resultant compiled program in a network storage location accessible by the smart contract 1018 such that the resultant compiled program may be released for integration into the platform 120 by the smart contract 1018.

Since the smart contract 1018 is a blockchain application, the smart contract 1018 may provide application user interfaces that enable users to view information related to the smart contract 1018 and provide user input to the smart contract 1018. For example, a user may access the application user interfaces of the smart contract 1018 via a web browser or a dedicated client application. However, in alternative embodiments, the smart contract 1018 may use helper applications, such as oracles, to receive user input from users. Further, the smart contract 1018 may include application functionalities and logic algorithms that determine whether the conditions for the smart contract 1018 to implement the new service feature are fulfilled. Thus, assuming that the voting by the decisionmakers 1014 of the organization satisfies the conditions of the smart contract 1018, i.e., the smart contract is approved by the decisionmakers 1014, the smart contract 1018 may self-execute to store the compiled program 1008 or a refined version of the compiled program 1008 into the designated network storage location as the deployed program 1020.

Similarly, an entity that coded the blockchain application 1010 for a new service feature may create a smart contract 1022 that enables the decisionmakers 1014 (e.g., stakeholders) of the organization that operates the platform 120 to decide whether the new service feature is to be integrated into the platform 120. The smart contract 1022 may be deployed in a similar manner as the smart contract 1012 for voting by the decisionmakers 1014 of the organization. The smart contract 1022 may set out conditions for implementing the new service feature provided by the blockchain application 1010 into the platform 120. For example, the conditions may specify a period of time during which decisionmakers 1014 of the organization can vote to decide whether the implementation should occur, the minimum number of votes that constitute a quorum, the percentage of votes from the decisionmakers 1014 that constitutes an approving majority for the integration, and/or so forth. The smart contract 1022 may further provide a detailed explanation of the purpose and functionalities of the blockchain application 1010 and a link to a networked repository location where the blockchain application 1010 is located. The networked repository location may also provide a sandbox environment that includes dummy data, software applications, APIs of third-party applications, and/or so forth for which the blockchain application 1010 may be executed against to demonstrate the efficacy and utility of the application.

In some instances, the smart contract 1022 may specify that in case of approval by a majority of the decisionmakers 1014 of the organization, whether the new service feature provided by the blockchain application 1010 may be directly integrated into the platform 120 or integrated after further development by a designated software development team. The integration may include releasing the blockchain application 1010 into a designated network storage location for access and execution by users of the platform 120. In contrast, further development may include performing code review, code editing, code testing, code debugging, code rewriting, code refactoring, and/or so forth with respect to the source code of the blockchain application 1010. In this way, the software development team may be employed to ensure that the blockchain application 1010 is error-free and can reliability provide the service features under various execution conditions. Subsequently, the development team may store the resultant blockchain application into a network storage location accessible by the smart contract 1022 such that the resultant blockchain application may be released for integration into the platform 120 by the smart contract 1022.

Since the smart contract 1022 is a blockchain application, the smart contract 1022 may provide application user interfaces that enable users to view information related to the smart contract 1022 and provide user input to the smart contract 1022. For example, a user may access the application user interfaces of the smart contract 1022 via a web browser or a dedicated client application. However, in alternative embodiments, the smart contract 1022 may use helper applications, such as oracles, to receive user input from users. Further, the smart contract 1022 may include application functionalities and logic algorithms that determine whether the conditions for the smart contract 1022 to implement the new service feature are fulfilled. Thus, assuming that the voting by the decisionmakers 1014 of organization satisfies the conditions of the smart contract 1022, i.e., the smart contract is approved by the decisionmakers 1014, the smart contract 1022 may self-execute to store the blockchain application 1010 or a refined version of the blockchain application 1010 into the designated network storage location as the deployed blockchain application 1024.

In alternative embodiments, each of the script 1006, the compiled program 1008, and the blockchain application 1010 may code multiple new service features for integration into platform 120. However, such new feature service features may be approved via corresponding smart contracts for integration into the platform 120 in a similar manner.

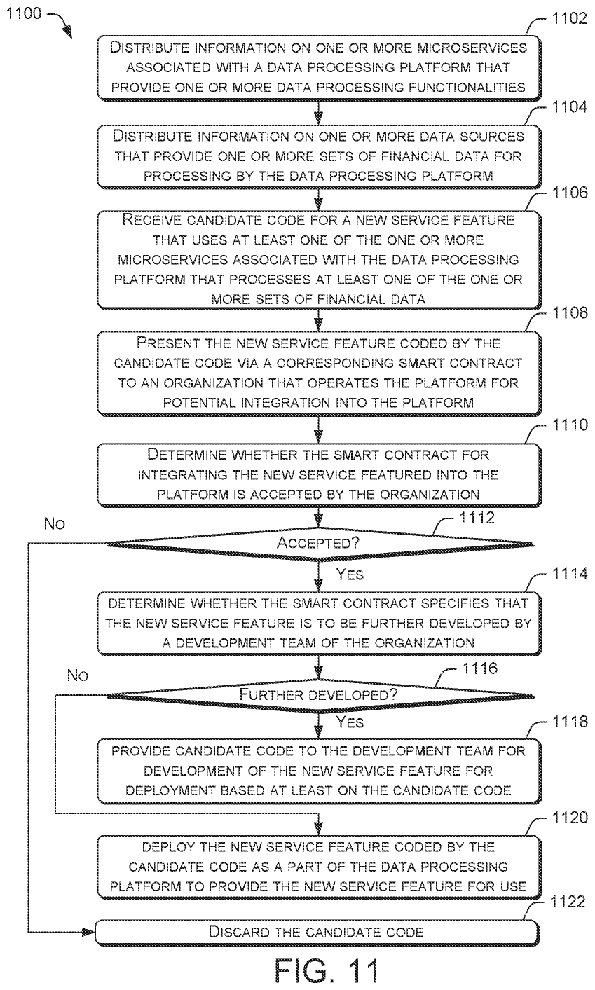

FIG. 11 is a flow diagram of an example process 1100 for using a microservice-based architecture of a data processing platform to generate and integrate service features into the platform. The process 1100 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

At block 1102, information on one or more microservices associated with a data processing platform that provides one or more data processing functionalities, such as the cost basis setting platform 120, may be distributed to one or more entities. For example, an organization that is operating the platform may provide documentation on the microservices and their APIs via a publicly accessible website that is operated by the organization. Alternatively, the organization may make the APIs of the microservices of the platform 120 publicly accessible such that the functions of the microservices may be ascertained by third parties via dynamic discovery. At block 1104, information on one or more data sources that provide one or more sets of financial data may be distributed to the one or more entities. For example, an organization operating the platform 120 may publish such information on the data sources on a publicly accessible website that is operated by the organization.

At block 1106, candidate code for a new service feature that uses at least one of the one or more microservices associated with the data processing platform that processes at least one of the one or more sets of financial data may be received from an entity of the one or more entities. The candidate code may be coded to call the at least one microservice via one or more APIs and/or access the least one set of financial data via one or more APIs. In various embodiments, the candidate code may be the source code for a script, a compiled program, or a blockchain application. In some embodiments, the source code may also encode some data processing functions that are to be performed in conjunction with the data processing performed by the at least one microservice.

At block 1108, the new service feature coded by the candidate code may be presented via a corresponding smart contract to the organization that operates the platform for potential integration into the data processing platform. The smart contract is a blockchain application that executes in a blockchain execution environment. In various embodiments, the smart contract may be created by an entity that generated the candidate code. The smart contract may be deployed to a blockchain for execution by the blockchain execution environment.

At block 1110, a determination is made as to whether the smart contract for integrating the new service feature into the data processing platform is accepted by the organization. For example, the smart contract, i.e., blockchain application, may set out conditions for implementing the new service feature coded by the candidate code into the data processing platform. The conditions may specify a period of time during which decisionmakers of the organization can vote to decide whether the implementation should occur, the minimum number of votes that constitute a quorum of decisionmakers, the percentage of votes from the decisionmakers that constitutes an approving majority for the integration, and/or so forth.

At decision block 1112, if the smart contract is accepted by the organization, the process 1100 may proceed to block 1114. In various embodiments, the smart contract is accepted when the conditions set by the smart contract are fulfilled by the decisionmakers of the organization. At block 114, a determination may be made as to whether the smart contract specifies that the new service feature is to be further developed by a development team of the organization. At decision block 1116, if the new service feature is to be further developed, the process 1100 may proceed to block 1118. At block 1118, the candidate code may be provided to the development team for development of the new service feature for deployment based at least one the candidate code. The development may include code review, code editing, code testing, code debugging, code rewriting, code refactoring, and/or so forth. In instances in which the candidate code is the source code for a compiled program or a blockchain application, the candidate code may be compiled into the compiled program or the blockchain application for deployment. The deployment may integrate the new service feature into the data processing platform.

However, if at decision block 1116 the new service feature is not to be further developed, the process 110 may proceed to block 1120. At block 1120, the new service feature coded by the candidate code may be deployed as a part of the data processing platform to provide the new service feature for use. In some instances, the new service feature may be used to process at least one of the one or more sets of financial data. In various embodiments, a corresponding script, a corresponding compiled program, or a corresponding blockchain application may be deployed to the data processing platform.

Returning to decision block 1112, if the smart contract is not accepted by the organization, the process 1100 may proceed to block 1122. For example, the smart contract may be unaccepted if at least one condition set by the smart contract, i.e., the blockchain application is unfulfilled. At block 1122, the candidate code may be discarded.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable storage media collectively storing computer-executable instructions that upon execution cause one or more computing devices to collectively perform acts comprising:
distributing information on one or more microservices associated with a data processing platform to one or more entities, the one or more microservices providing one or more data processing functionalities;
distributing information on one or more data sources that provide one or more sets of financial data for processing by the data processing platform to the one or more entities;
receiving candidate code for a new service feature that uses at least one of the one or more microservices associated with the data processing platform that processes at least one of the one or more sets of financial data, the candidate code being generated by an entity of the one or more entities;
presenting the new service feature coded by the candidate code via a corresponding blockchain application to an organization that operates the data processing platform for potential integration into the data processing platform, the blockchain application specifying a set of conditions for integration of the new service feature into the data processing platform; and
deploying the new service feature coded by the candidate code as a part of the data processing platform in response to the set of conditions being fulfilled.

2. The one or more non-transitory computer-readable storage media of claim 1, wherein the acts further comprise discarding the candidate code in response to at least one of the conditions being unfulfilled.

3. The one or more non-transitory computer-readable storage media of claim 1, wherein the distributing the information on the one or more microservices include providing information on one or more application program interfaces (APIs) of the one or more microservices, and wherein the distributing the information on the one or more data sources includes providing information on one or more APIs for accessing the one or more data sources.

4. The one or more non-transitory computer-readable storage media of claim 1, wherein the candidate code codes a script, a compiled program, or an additional blockchain application that uses the at least one of the one or more microservices.

5. The one or more non-transitory computer-readable storage media of claim 1, wherein the new service feature provides one or more additional data processing functions that are to be performed in conjunction with data processing performed by the at least one of the one or more microservices.

6. The one or more non-transitory computer-readable storage media of claim 1, and wherein the blockchain application is a smart contract that is created by the entity to execute in a blockchain execution environment.

7. The one or more non-transitory computer-readable storage media of claim 1, wherein the organization is a decentralized autonomous organization (DAO), and wherein the set of conditions includes a majority approval by members of the DAO to integrate the new service feature into the data processing platform.

8. The one or more non-transitory computer-readable storage media of claim 1, wherein the acts further providing the candidate code to a development team of the organization for development of the new service feature based at least on the candidate code when the blockchain application further specifies development by the development prior to integration of the new service feature into the data processing platform.

9. The one or more non-transitory computer-readable storage media of claim 8, wherein the development of the new service feature includes performing at least one code review, code editing, code testing, code debugging, code rewriting, code refactoring of the candidate code.

10. The one or more non-transitory computer-readable storage media of claim 1, wherein the data processing platform includes a plurality of microservices that generate financial reports including accounting entries based on transaction data received from at least one of one or more decentralized financial (DeFi) platforms or one or more centralized finance (CeFI) platforms.

11. The one or more non-transitory computer-readable storage media of claim 10, wherein the transaction data includes at least one action, and wherein the data processing platform at least generates one or more atomic primitive operations from the at least one action and uses the one or more atomic primitive operations to generate a financial report.

12. A system, comprising:
one or more processors; and
memory including a plurality of computer-executable instructions that are executable by the one or more processors to perform a plurality of actions, the plurality of actions comprising:
distributing information on one or more microservices associated with a data processing platform that provide one or more data processing functionalities to one or more entities;
distributing information on one or more data sources that provide one or more sets of financial data for processing by the data processing platform to the one or more entities;
receiving candidate code for a new service feature that uses at least one of the one or more microservices associated with the data processing platform that processes at least one of the one or more sets of financial data, the candidate code being generated by an entity of the one or more entities;
presenting the new service feature coded by the candidate code via a corresponding blockchain application to an organization that operates the data processing platform for potential integration into the data processing platform, the blockchain application specifying a set of conditions for integration of the new service feature into the data processing platform; and
deploying the new service feature coded by the candidate code as a part of the data processing platform in response to the set of conditions being fulfilled.

13. The system of claim 12, wherein the plurality of actions further comprise discarding the candidate code in response to at least one of the conditions being unfulfilled.

14. The system of claim 12, wherein the distributing the information on the one or more microservices include providing information on the one or more application program interfaces (APIs) of the one or more microservices, and wherein the distributing the information on the one or more data sources includes providing information on one or more APIs for accessing the one or more data sources.

15. The system of claim 12, wherein the candidate code codes a script, a compiled program, or an additional blockchain application that uses the at least one of the one or more microservices.

16. The system of claim 12, wherein the new service feature provides one or more additional data processing functions that are to be performed in conjunction with data processing performed by the at least one of the one or more microservices.

17. The system of claim 12, wherein the blockchain application is a smart contract that is created by the entity to execute in a blockchain execution environment.

18. The system of claim 12, wherein the data processing platform includes a plurality of microservices that generate financial reports including accounting entries based on transaction data received from at least one of one or more decentralized financial (DeFi) platforms or one or more centralized finance (CeFI) platforms.

19. A computer-implemented method, comprising:
distributing information on one or more microservices associated with a data processing platform that provide one or more data processing functionalities to one or more entities;
distributing information on one or more data sources that provide one or more sets of financial data for processing by the data processing platform to the one or more entities;
receiving candidate code for a new service feature that uses at least one of the one or more microservices associated with the data processing platform that processes at least one of the one or more sets of financial data, the candidate code being generated by an entity of the one or more entities;
presenting the new service feature coded by the candidate code via a corresponding blockchain application to an organization that operates the data processing platform for potential integration into the data processing platform, the blockchain application specifying a set of conditions for integration of the new service feature into the data processing platform;
deploying the new service feature coded by the candidate code as a part of the data processing platform in response to the set of conditions being fulfilled; and
discarding the candidate code in response to at least one of the conditions being unfulfilled.

20. The computer-implemented method of claim 19, wherein the new service feature provides one or more additional data processing functions that are to be performed in conjunction with data processing performed by the at least one of the one or more microservices.
